(19) United States
(12) Patent Application Publication
(10) Pub. No.: US 2019/0271795 A1
(43) Pub. Date: Sep. 5, 2019

(54) SUBSTANCE DETECTION SYSTEM

(71) Applicant: Johnnie Bea Grogan, Roswell, NM (US)

(72) Inventor: Johnnie Bea Grogan, Roswell, NM (US)

(21) Appl. No.: 16/285,561

(22) Filed: Feb. 26, 2019

Related U.S. Application Data
(60) Provisional application No. 62/637,371, filed on Mar. 1, 2018.

(51) Int. Cl. G01V 7/08

(52) U.S. Cl. CPC G01V 7/08

(57) ABSTRACT

Disclosed is a detector device for detecting the presence of a target substance, the device comprising: a detection rod having a longitudinal rod body, composed of a conductive and non-magnetic material and a support structure configured to support the detection rod at an fulcrum site between a detection end and the counterbalance end of the detection rod. The support structure is configured to sustain the detection rod in a static state absent an external force and to guide a rotation of the detection rod in response to an external force, which may include a force effectuated by the presence of the target substance.

### BACKGROUND

The ability to detect a concealed or unknown substance without invasive and laborious searching has a wide variety of uses and applications such as increasing security at airports and event venues, border patrol and security, drug detection, treasure hunting, to name but a few. Accordingly, an effective and low cost substance detection system is highly desirable and beneficial.

### SUMMARY

In accordance with various embodiments, disclosed is a detector device for detecting the presence of a target substance, the device comprising: a detection rod having a longitudinal rod body, the rod body having a detection end and a counterbalance end opposite the detection end; and a support structure comprising a support shaft, the support shaft coupled to the rod body in approximate perpendicular alignment to the rod body, and between the detection end and the counterbalance end, wherein the detection rod is configured to sustain a static state absent an external force, and to rotate according to an axial rotation of the support shaft, in response to an external force, the external force including a force effectuated by the presence of the target substance within a detection range of the detection rod. In some embodiments, the rod body is uniformly composed of a conductive material, and the support shaft is coupled to an approximate center of mass of the rod body. The conductive material may be magnetic or non-magnetic, according to various embodiments. In other embodiments, the device further comprises at least one detection mass coupled to the rod body on a detection side of the rod body, the detection side being a section of the rod body between the support shaft and detection end; and at least one counterbalance mass coupled to the rod body on a counterbalance side of the rod body, the counterbalance side being a section of the rod body between the support shaft and the counterbalance end, wherein a mass value of the at least one detection mass is approximately equal to a mass value of the at least one counterbalance mass, and wherein the at least one detection mass and the at least one counterbalance mass are composed of the same material, the material being conductive. In yet other embodiments, a center of mass of the at least one detection mass is slightly further from the support shaft than the center of mass of the at least one counterbalance mass.

In some embodiments, a position of the at least one detection mass, a position of the at least one counterbalance, or both, is adjustable with respect to the rod body. In other embodiments, the at least one detection mass, the at least one counterbalance, or both, include two or more distinct mass bodies. In other embodiments, the at least one detection mass comprising a primary mass body and a secondary mass body, wherein the mass value of the primary mass body is greater than the mass value of the secondary mass body, wherein a position of the secondary mass body is adjustable with respect to the rod body and is distanced further from the support shaft than the primary mass body. In yet other embodiments the mass value of the primary mass body is approximately ⅔ of a total mass value of the at least one detection mass, and wherein the mass value of the secondary mass body is approximately ⅓ of the total mass value of the at least one detection mass. In some embodiments, the support structure further comprises a handle configured to retain and guide an axial rotation of the support shaft in a low friction engagement. In yet other embodiments, the detector further comprises a holder for containing a sample of the target substance.

In accordance with various embodiments, disclosed is a detector device for detecting the presence of a target substance, the device comprising: a detection rod having a longitudinal rod body, the rod body having a detection end and a counterbalance end opposite the detection end, wherein the rod body is uniformly composed of a conductive and non-magnetic material; and a support structure, wherein the support structure is configured to support the detection rod at an fulcrum site between the detection end and the counterbalance end of the detection rod, wherein the support structure is configured to sustain the detection rod in a static state absent an external force, and wherein the support structure is configured to guide a rotation of the detection rod in response to an external force, the rotation being about an axis running through the fulcrum site and approximately orthogonal to the rod body, and the external force including a force effectuated by the presence of the target substance. In some embodiments, the fulcrum site is approximately at a longitudinal center of the rod body. In other embodiments, the device further comprises at least one detection mass coupled to the rod body on a detection side of the rod body, the detection side being a section of the rod body between the fulcrum site and detection end; and at least one counterbalance mass coupled to the rod body on a counterbalance side of the rod body, the counterbalance side being a section of the rod body between the fulcrum site and the counterbalance end. In further embodiments, a mass value of the at least one detection mass is approximately equal to a mass value of the at least one counterbalance mass. In yet further embodiments, the at least one detection mass and the at least one counterbalance mass, are composed of the same material, which is a conductive material.

In some embodiments, the fulcrum site is at approximately a center of mass of the rod body, and a center of mass of the at least one detection mass is slightly further from the fulcrum site than the center of mass of the at least one counterbalance mass. In further embodiments, a position of the at least one detection mass, a position of the at least one counterbalance mass, or both, is adjustable with respect to the rod body. In yet further embodiments, the at least one detection mass includes at least two distinct mass bodies. In yet further embodiments, the at least two distinct mass bodies comprise a primary mass body and a secondary mass body, wherein the mass value of the primary mass body is greater than the mass value of the secondary mass body, and wherein the secondary mass body is distanced further from the support shaft than the primary mass body. In yet further embodiments, a position of the secondary mass body is adjustable with respect to the rod body.

In some embodiments, the support structure comprises a support shaft coupled to the rod body in approximate perpendicular alignment to the rod body, at the fulcrum site of the detection rod. In further embodiments, the support structure comprises a handle, configured to support the detection rod while held by a user. In yet further embodiments, the support structure comprises: a support shaft coupled to the rod body in approximate perpendicular alignment to the rod body, and at the fulcrum site of the detection rod; and a handle configured to retain and guide an axial rotation of the support shaft.

In accordance with various embodiments, disclosed is a method for detecting a target substance, comprising: providing a detector comprising a detection rod having a longitudinal rod body, the rod body having a detection end and a counterbalance end opposite the detection end, wherein the rod body is uniformly composed of a conductive material, and wherein the detection rod is configured to rotate, in response to an external force, about an axis approximately perpendicular to the rod body and at a fulcrum site of the rod body, between the counterbalance and the detection end; and determining the presence or absence of the target substance within a detection range of the detection rod, based on a rotation or absence of rotation of the detection rod, respectively. In some embodiments, the method further comprises placing a sample substance proximate the detection rod, the sample substance matching the target substance. In further embodiments, the sample substance is placed within a holder, and wherein the holder is placed in direct contact with the detector. In further embodiments, the method further comprises providing at least one detection mass on a detection side of the rod body between the fulcrum site and the detection end, and providing at least one counterbalance mass on a counterbalance side of the rod body, between the fulcrum site and the counterbalance end. In further embodiments, the method further comprises adjusting a position of the at least one detection mass, the least one counterbalance mass, or both. In yet further embodiments, the at least one detection mass is positioned at a radial distance from the fulcrum site which is greater than the radial distance from the fulcrum site of the at least one counterbalance mass. In further embodiments, the method further comprises providing a support structure, which is configured to support the detection rod for rotation about the fulcrum site. In further embodiments, the method further comprises holding the support structure via a handle of the support structure. In some embodiments, the support structure comprises a support shaft coupled to the detection rod at the fulcrum site, and oriented approximately perpendicular to the rod body. In other embodiments, the support structure further comprises a handle configured to retain and guide a rotation of the support shaft.

### BRIEF DESCRIPTION OF THE DRAWINGS

The drawings described herein are for illustration purposes only and are not intended to limit the scope of the present disclosure in any way. The present disclosure will become more fully understood from the detailed description and the accompanying drawings wherein:

FIG. 1 is a perspective view of a detector device in a dissembled state, in accordance with various embodiments;

FIG. 2 illustrates the detector device of FIG. 1, in an assembled state, according to various embodiments;

FIG. 3 illustrates the detector device of FIG. 2, showing the detection mass divided into two distinct mass bodies, according to various embodiments;

FIG. 4 illustrates the detector device of FIG. 2, showing an alternate configuration for the support shaft, according to various embodiments; and

FIG. 5 illustrates a detector method, according to various embodiments.

### DETAILED DESCRIPTION OF PREFERRED EMBODIMENTS

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. Furthermore, the terms “approximate”, “approximately”, “about”, etc. refer to a deviation of +/−5% of the whole, based on the context, unless explicitly stated otherwise. For example “approximately perpendicular” refers to an angle of 90°+/−9° (based on 180° as the whole); “approximately central” in reference to a 10 inch rod, refers to 5+/−0.5 inches from the end of the rod; “about 5%” refers to 5%+/−0.25%, etc.

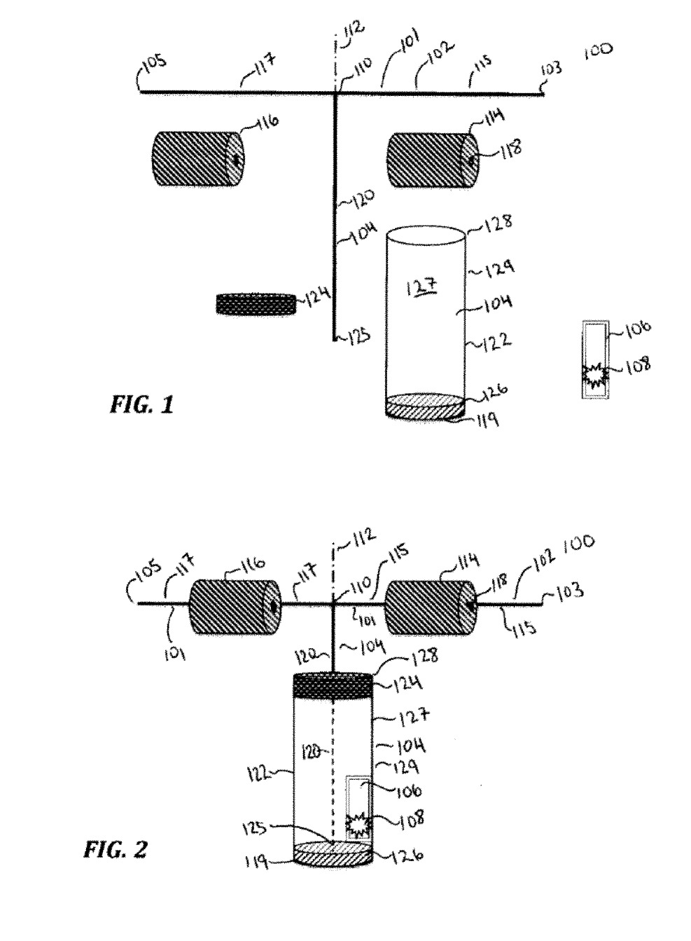

With reference to FIGS. 1-4, a detector device 100 for detecting the presence of a target substance, in accordance with various embodiments, comprises a detection rod 102, and a support structure 104 for the detection rod 102. In embodiments, the device may further comprise a holder 106 for a target substance sample 108.

In certain embodiments, some or all of the components of device 100 may be configured for assembly and disassembly, (e.g. by a user), as shown in FIG. 1. In other embodiments, some or all of the device components may be preassembled (see FIGS. 2-4).

As shown in the figures, the detection rod 102 generally comprises a longitudinal rod body 101 having a detection end 103 and a counterbalance end 105, which is opposite the detection end 103. In embodiments, the support structure 104 is configured to support the detection rod 102 at a fulcrum site 110, between ends 103 and 105, of the detection rod 102 and/or rod body 101, in a manner which leaves the detection rod 102 free to rotate about a rotation axis 112 which is approximately orthogonal to the longitudinal rod body 101, and which runs through fulcrum site 110. The support structure 104 may further be configured to guide the rotation of the detection rod 102.

In various embodiments, the fulcrum site 110 may be at a central region, which may included a center and/or an approximate longitudinal center of the rod body 101. In embodiments, the fulcrum site 110 may be slightly removed from a center of mass of the detection rod 102 and/or rod body 101, but supported by the support structure, such that the detection rod 102 is configured to remain in static equilibrium absent a rotational force, and to rotate or pivot about axis 112 in response to a rotational force. For example, the fulcrum site 110 may be shifted from the center of the rod body 101 between about 0.5% and 15% of the rod body length, or between about 1% and 10%, or between about 2% and 8%, or between about 3% and 5%, or at about 3% of the rod body length, according to various embodiments. In some embodiments, the fulcrum site 110 may be approximately at a longitudinal center and/or center of mass of the rod body 101, but shifted due to additional mass elements on the rod body 101, as described below. This configuration allows the detection rod 102 to remain in static equilibrium absent a rotational force, and to rotate or pivot about axis 112 in response to a rotational force, which may be effectuated by the presence of a target substance in proximity to, i.e. within a detection range (see below) of the detection rod 102.

According to various embodiments, the rod body 101 is uniformly comprised of a conductive material. In embodiments, the conductive material may be a metal such as iron, or steel, for example, which may be magnetic or non-magnetic. In embodiments, the rod body 101 may be a coated metal. In various embodiments, the rod body 101 may have, but is not limited to, a cylindrical configuration. In some embodiments, at least a portion of the rod body 101 may be threaded. The length and diameter of the rod body 101 may depend on factors such as the specific detection application, desired detection range, dimension(s) and/or weight(s) of mass(s) added to the rod body, etc. A length of the rod body 101 may be, for example, between approximately 5 and 50 inches, or between approximately 10 and 30 inches. For example, the length may be approximately 10 inches, 12 inches, 20 inches, 25 inches, etc., according to various embodiments. Additionally, a diameter of the rod body 101 may be between approximately 0.125 and 1 inch. For example, a diameter of the rod body may be approximately 0.125, 0.1875, or 0.5 inches, according to various embodiments.

In embodiments, the detection rod 102 may comprise at least one detection mass 114 on a detection side 115 of the rod body 101; the detection side being a section of the rod body 101 between the fulcrum site 110 and detection end 103. The detection rod 102 may further comprise at least one counterbalance mass 116 on a counterbalance side 117 of the rod body 101; the counterbalance side 117 being a section of the rod body 102 between the fulcrum site 110 and the counterbalance end 105.

In embodiments, the at least one detection mass 114 and the at least one counterbalance mass 116 have approximately equal mass or weight values. In various embodiments the detection mass 114 and the counterbalance mass 116 may be of the same material. (It may be advantageous for the masses 114 and 116 to be equal in weight and of the same material, as this may keep the detector device 100 from responding to the materials of the detector device 100 itself). In embodiments, the at least one detection mass 114 and the at least one counterbalance mass 116 may be made of a conductive material, which may be a metal, such as iron (e.g. hot rolled iron), stainless-steel, etc., and may include coated metals, for example; and may further be non-magnetic. In embodiments masses 114 and 116 may also be of the same material as the rod body 101.

The weight and size of the masses 114, 116, may depend on the various factors, such as the size of the rod 102, desired detector size and range, material availability, etc. In embodiments, the masses 114 and 116 may be between approximately 0.25 to 5 pounds each, or between 0.5 and 3 pounds each, or between 0.75 and 2 pounds each. For example, the masses may be about 1 pound, about 1.5 pounds, about 2 pounds, etc., according to various embodiments.

The distance of the masses 114 and 115 from the fulcrum site 110 may vary (though rotation is generally slowed with a longer radial distance). For example, the center of mass of each of mass 114 and 116 may be positioned at about 0.2 to about 0.9 of a radial distance (i.e. distance from the fulcrum site 110 to the respective end (103 or 105) of the rod body 101); or from about 0.25 to about 0.85 of the radial distance; or from about 0.3 to about 0.7 of the radial distance, according to various embodiments. According to an exemplary embodiment, the radial distance may be between about 2 and 3 inches.

In embodiments, the distance between the center of mass of the detection mass 114 and detection end 103 is slightly less than the distance between the center of mass of the counterbalance mass 116 and counterbalance end 105. In other words, the detection mass radial distance (i.e. distance between fulcrum site 110 and center of mass of mass 114) is slightly greater than the counterbalance mass radial distance (i.e. distance between fulcrum site 110 and center of mass of mass 116). In operation, this slight off-centering of the center of masses renders the side 115 or end 103 as the active side/end that will point to the target material, while the side 117 or end 105 serves as a counterbalance, which keeps the detection rod 102 in static equilibrium, absent an external rotational force, such as a force effectuated by the presence of a target substance in proximity to the detection rod 102.

In embodiments, the detection mass 114, the counterbalance mass 116, or both may be coupled to the rod body 101 at a fixed position. For example, mass 114 and/or mass 116 may permanently joined to the rod body 101 by various known processes, e.g. welding, brazing, etc. In embodiments, a position of the detection mass 114, the counterbalance mass 116, or both, may be adjustable with respect to the rod body 101 to allow a user to tune a sensitivity of the detector device 100, which may be accomplished by increasing the moment arm of the mass. In some embodiments, a portion of mass 114 and/or mass 116 may be fixed, while another portion of mass 114 and/or mass 116 may be adjustable. The position of detection mass 114 and/or counterbalance mass 116 may be made adjustable, for example, by providing a threaded or sliding coupling arrangement, between the mass and rod body 101. (e.g. mass 114 and/or mass 116 may include an interior bore 118, configured for sliding or threaded engagement with rod body 101 having a circular cross-section). Additionally, any coupling components for fixed and/or adjustable coupling (e.g. nuts, bolts, washers, etc.) may be made of a conductive material, e.g. metal such as iron, stainless steel, coated metal, etc., according to various embodiments.

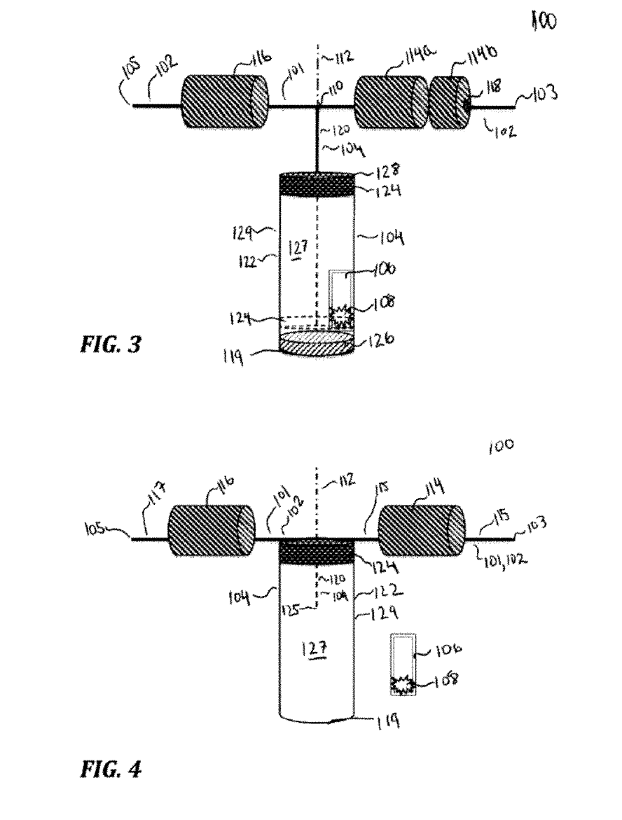

According to an exemplary embodiment, the at least one detection mass 114 and/or the at least one counterbalance mass 116 may be comprised of two or more separate mass bodies. Additionally, at least one of the separate mass bodies may be position adjustable. This allows for modulating the sensitivity of the center of mass adjustment. For example, as shown in the FIG. 3, detection mass 114 may include 2 mass bodies comprising a primary mass body 114a and a secondary mass body 114b. In embodiments, primary mass body 114a and secondary mass body 114b may be of equal mass value. In other embodiments, primary mass body 114a and the secondary mass body 114b may be of unequal value. In certain embodiments, the mass body closer to the end (i.e. secondary mass body 114b) may have a smaller mass value than primary mass body 114a. This configuration enables finer tuning in adjusting the center of mass. For example, the mass value of the secondary mass 114b may be between about 0.4 and 0.1 of the total mass value of mass 114, while the primary mass 114a may make up the remaining mass of detection mass 114. According to an exemplary embodiment, the primary mass body 114a may equal to approximately ⅔ of the total of detection mass 114, and the secondary mass body 114b may be equal to approximately ⅓ of the total mass of detection mass 114; while the counterbalance mass 116 may include one mass body, having a mass value equal to that of the total of detector mass 114.

According to various embodiments, the support structure 104 may comprise a support shaft 120 and/or a handle 122.

In embodiments, the support shaft 120 may be coupled approximately perpendicular to the longitudinal body 101 between the detection side 115 and counterbalance side 117, in a manner which allow the detection rod to pivot or rotate about the support shaft 120. Thus, the shaft 120 may be coupled at the fulcrum site 110 and may be described as forming the site 110 and/or rotational axis 112.

In various embodiments, the support shaft 120 may be made of a conductive material (e.g. metal such as iron, stainless steel, etc.). In embodiments, the material of the support shaft 120 may be the same as that of the rod body 101.

In embodiments, support shaft 120 may be fixedly coupled to the rod body 101 (e.g. by welding, brazing, etc.). In embodiments, the handle 122 may be configured to support the detection rod 102 through the support shaft 120, wherein the handle 122 may be configured to retain the support shaft 120 in a manner which allows a 360° axial rotation of the shaft 120, within the handle 122.

In embodiments, the handle 122 may include at least one retainer 124 for supporting and/or guiding a rotation of the support shaft 120. The at least one retainer 124 may be a low friction retainer, such as a bushing (e.g. nylon bushing), bearing (e.g. ball bearing), etc., for example. In some embodiments, the handle 122 may include 2 or more retainers 124.

In some embodiments, a bottom end of the support shaft 120 may rest on a bottom surface 119 of the handle 122. The handle 122 may include a support bottom 126 for the support shaft 120, such as a flat metal plate, or other low friction surface upon which the bottom end 125 of the support shaft 120 may rest or freely spin. In some embodiments, the bottom end 125 may be beveled, rounded, and/or pointed to minimize the contact area and friction. In some embodiments, the bottom end 125 of the support shaft may be suspended above the bottom surface 119 of the handle 122, as illustrated in FIG. 4.

In embodiments, the handle 122 may be formed of a non-conductive material. For example, the handle body 127 may be comprised of a PVC pipe, wherein the retainer 124 may be positioned at a top end 128 of the handle 122, against the bottom surface 119 of the handle, and/or at any section in-between (see FIG. 3), and may be held within the handle body 127.

Various other configurations for a support structure may be apparent to one skilled in the art. For example, a support structure including a suspension support for the detection rod 102 may be configured, according to various embodiments.

In some embodiments, the device 100 may further include holder 106 to contain a sample 108 of the target substance. In embodiments, the holder 106 may be a container made of an insulating material, such as plastic, glass, nylon, etc., and may include a lid or closure. The holder may be, for example, a glass vial, a plastic bag, and the like, according to various embodiments. The holder 106 containing the sample 108 may be placed in proximity to the device 100, but need not necessarily be in contact with the device 100. In embodiments, the holder 106 containing the sample 108 may be positioned in contact with the device. For example, it may be placed within the handle 122, as shown in FIGS. 2 and 3, or coupled to an outer portion 129 of the handle body 127; or the holder 106 may be in contact with the detection rod, or support shaft, according to various embodiments. In embodiments, the sample 108 may be in proximity (i.e. 6 inches or closer) to the device 100, and need not necessarily be placed in the holder 106. It is believed that a field from the sample 108 radiates throughout the entire detector making the entire mass appear as the sample material with the leading end rotating and pointing toward the target.

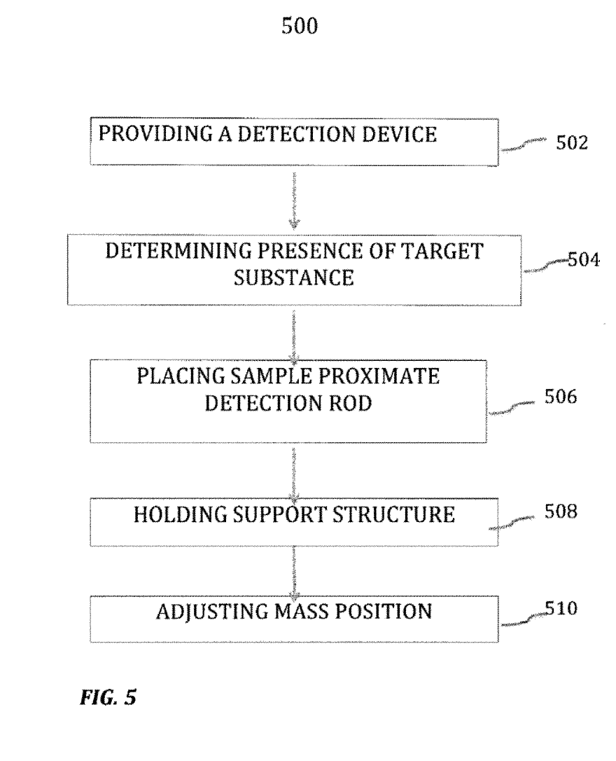

FIG. 5 illustrates a method 500 for detecting a presence or absence of a target substance, in accordance with various embodiments. The method 500 may comprise a step 502 of providing a detection device comprising a detection rod, made of a conductive material, configured to pivot (i.e. rotate) about a fulcrum site of the detection rod in response to an external force, wherein the external force may include the presence of the target substance within a detection range of the detection rod. The fulcrum site of the detection rod may be between a detection end and a counterbalance end of the rod. The rod may further include at least one detection mass on a detection side of the rod body between the fulcrum site and the detection end, and at least one counterbalance mass on a counterbalance side of the rod body, between the fulcrum site and the counterbalance end. In embodiments, method 500 may further comprise a step 510 of adjusting a position of the at least one detection mass and/or at least one counterbalance mass, the detection mass and counterbalance mass each being coupled to the detection rod. In embodiments, a center of mass of the detection mass may be positioned slightly further from the fulcrum site than a center of mass of the counterbalance mass 116.

Method 500 may further comprise a step 504 of determining a presence or absence of the target substance within the detection range of the detection rod, based on a rotation or a non-rotation of the detection rod. In embodiments, method 500 may further include a step 506 of placing a small quantity of a sample substance proximate the detection rod (e.g. within 1 meter from the device), where the sample substance matches the target substance. In embodiments, the sample may be within about 6 inches of the detection device. In embodiments, the sample substance may be coupled to the detection device via an insulator (i.e. the sample may be placed in a holder made of an insulating material, such as glass or plastic, wherein the holder may be in direct contact with the device). According to various embodiments, the holder need not necessarily be in direct contact. In embodiments, step 506 may include placing the sample substance in a holder, which may be made of an insulating material. In embodiments, the holder may be a glass vial, or a plastic bag. In embodiments, step 506 may further include placing the holder containing the target substance in contact with the detector device. For example, the holder containing the target substance may be placed within a handle of the device.

In embodiments, method 500 may further comprise a step 508 of holding a support structure upon which the detection rod is supported for rotation. The detection rod within the support structure may be held in an upright position, wherein the detection rod is free to rotate 360°. Additionally, a user holding the detector rod may move around the suspected target.

According to various embodiments, the support structure may include a support shaft at the fulcrum site of the detection rod and/or rod body. The support shaft may be oriented approximately orthogonal to the rod body. In embodiments, the support structure may further include a handle made of a non-conductive material. In embodiments, the handle may be configured to retain and guide a rotation of the support shaft within the handle.

Various tests conducted showed that the detector changes directions to always point to the target, as a user (either sitting or standing) moves past the target, while holding the device.

### Detection Range

In embodiments, the detection range (or energy field radius) of the rod for a given target substance may depend on the size and weight of the rod and its components, and the target substance. Approximate detection ranges for a detector device as depicted in FIG. 2, were measured using a gold sample, comprising a few milligrams of gold in a glass vial, with results provided in the table below. The detector device included a detection rod having a length of approximately 10 inches, and 0.25 inch diameter; a handle comprising 0.75 inch PVC pipe, with a flat metal plate on the bottom for the support rod to rest on; and two iron masses (hot roll round stock, soft iron) of varying sizes/weights. The gold sample in the glass vial was found to create a detection (energy) field of 12 inches. Using the various masses listed in the table detection fields (i.e. measured radius of the energy field or “Energy Field Radius”) were measured, and found to be between approximately 7 and 25 feet, as listed in the table below.

TABLE 1
Example of Detection Range

| | | Mass | | |
|---|---|---|---|---|
| | Overall | diameter | Mass length | Energy |
| | Detector | (for each | (for each | Field |
| | mass | mass, in | mass, in | Radius |
| | (in Kg) | inches) | inches) | (in Feet) |
| Detector 1 (small | 0.85 | 1.25 | 2⅜ | 7 |
| size, 10 inch length | | | | |
| detection rod) | | | | |
| Detector 2 (medium | 1.4 | 1.5 | 3 | 16 |
| size, 10 inch length | | | | |
| detection rod) | | | | |
| Detector 3 (large | 2.37 | 2 | 3 | 25.25 |
| size, 10 inch length | | | | |
| detection rod) | | | | |

As can be seen, the detection range increases with the size/weight of the detector mass (It is believed that the mass of the detector may serve as an amplifier in that the energy field of a small sample (e.g. several milligrams) is induced into the mass which makes an apparent mass equal to the total mass of the detector; additionally, it is believed that increasing the mass, as well as adjusting the sensitivity, may eliminate false indications). Thus, the size of the detector device 100 may make it more or less suitable for a given application. For example, the above detectors may all be suited for treasure and meteorite hunting. The “medium size” detector, which may include an adjustable active end, or one with a fixed position may be especially practical for security use.

Additionally, a wide range of targets can be located simply by changing the sample. Any sample can be used with the detector to identify and locate a wide range of targets; and the detector uses the energy of the target material as the power source.

### Distance Detection Test Results

Tests for determining the detection distances for various substances were performed; with results listed in the Table below. (The tests were performed approximately 30 miles East of Roswell, N. Mex. away from most interferences):

TABLE 2

| Substance | Detection distance | |
|---|---|---|
| 20 grams of marijuana | 0.44 | miles |
| 0.38 oz. of gold | 450 | feet |
| 40 caliber Semi auto pistol | 0.31 | miles |
| with 7 rounds | | |
| Two 40 caliber bullets | 175 | feet |
| Fifty 40 caliber bullets | 0.78 | miles |
| Twenty-five 40 caliber bullets | 0.57 | miles |
| 20 oz. silver | 1.10 | miles |
| 10 oz. silver | 0.79 | miles |

Other tests performed using smokeless gunpowder as the sample showed the detection of guns, or ammo, with 100% accuracy in over 20 passing police cars. The detection range was typically at well over 200 feet. Other tests showed that 1 ounce sample of silver may produce an energy field 19 feet which gives an apparent mass of 695,000 kg based on the weight of soil at 1.7 kg per cubic meter. These tests indicate that any mass may radiate energy outward in all directions, which may be induced into adjacent mass.

### Mass Attraction Calculation Results

The following test results were made by measuring the target and detector energy field radii, for various substances, as the sphere radius. An effective mass was calculated by the sphere volume divided by 2, and using 1700 kg per cubic meter as the multiplier for total mass. The mass attraction was calculated using the standard gravitational formula with target and detector energy field mass, and the detection distance as the radius. (Note: It takes approximately 0.04 Newton move the detector from rest.)

TABLE 3

| | | Detector | Detection | Results | |
|---|---|---|---|---|---|
| Substance | Energy field | Field | distance | (effective mass) | |
| 40 cal bullet | 11 feet | 14′ 2″ | 28′ | .042 | Newton |
| 1 oz silver | 19 feet | 11′ | 48′6″ | .0285 | Newton |
| 0.38 oz gold | 14 feet | 14′10″ | 39′4″ | .05 | Newton |
| | 10 inches | | | | |

Thus, the detector may be useful in areas of national security, including border patrol and/or border security, for detection of drugs, human trafficking, gunpowder, etc.

The disclosed detection device and method is further contemplated for possible application in pharmaceuticals, for medical treatments for conditions such as depression, cancer, chemical dependencies, or any application where the energy field of the pharmaceutical may affect a subject. It is contemplated that rather than taking an actual drug, which may carry side effects, an energy field of the drug may instead be effective for treatment.

Additionally, the disclosed device 100 may be provided as an entertainment, toy, and/or novelty item; for example, the device may be a toy for use in a “treasure hunt” game and the like, according to various embodiments. Such device may include all of the features of the device 100 used as a detector device.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A detector device for detecting the presence of a target substance, the device comprising:
a detection rod having a longitudinal rod body, the rod body having a detection end and a counterbalance end opposite the detection end; and
a support structure comprising a support shaft, the support shaft coupled to the rod body in approximate perpendicular alignment to the rod body, and between the detection end and the counterbalance end,
wherein the detection rod is configured to sustain a static state absent an external force, and to rotate according to an axial rotation of the support shaft, in response to an external force,
the external force including a force effectuated by the presence of the target substance within a detection range of the detection rod.

2. The detector device of claim 1, wherein the rod body is uniformly composed of a conductive material, and wherein the support shaft is coupled to an approximate center of mass of the rod body.

3. The detector device of claim 1, further comprising:
at least one detection mass coupled to the rod body on a detection side of the rod body, the detection side being a section of the rod body between the support shaft and detection end; and
at least one counterbalance mass coupled to the rod body on a counterbalance side of the rod body, the counterbalance side being a section of the rod body between the support shaft and the counterbalance end,
wherein a mass value of the at least one detection mass is approximately equal to a mass value of the at least one counterbalance mass, and
wherein the at least one detection mass and the at least one counterbalance mass are composed of the same material, the material being conductive.

4. The detector device of claim 3, wherein a center of mass of the at least one detection mass is slightly further from the support shaft than the center of mass of the at least one counterbalance mass.

5. The detector device of claim 3, wherein a position of the at least one detection mass, a position of the at least one counterbalance, or both, is adjustable with respect to the rod body.

6. The detector device of claim 3 wherein the at least one detection mass, the at least one counterbalance, or both, includes two or more distinct mass bodies.

7. The detector device of claim 3, the at least one detection mass comprising a primary mass body and a secondary mass body, wherein the mass value of the primary mass body is greater than the mass value of the secondary mass body, wherein a position of the secondary mass body is adjustable with respect to the rod body and is distanced further from the support shaft than the primary mass body.

8. The detector device of claim 7, wherein the mass value of the primary mass body is approximately ⅔ of a total mass value of the at least one detection mass, and wherein the mass value of the secondary mass body is approximately ⅓ of the total mass value of the at least one detection mass.

9. The detector device of claim 1, wherein the support structure further comprises a handle configured to retain and guide an axial rotation of the support shaft in a low friction engagement.

10. The detector device of claim 1, further comprising a holder for containing a sample of the target substance.

11. A detector device for detecting the presence of a target substance, the device comprising:
a detection rod having a longitudinal rod body, the rod body having a detection end and a counterbalance end opposite the detection end, wherein the rod body is uniformly composed of a conductive and non-magnetic material; and
a support structure,
wherein the support structure is configured to support the detection rod at an fulcrum site between the detection end and the counterbalance end of the detection rod,
wherein the support structure is configured to sustain the detection rod in a static state absent an external force,
and wherein the support structure is configured to guide a rotation of the detection rod in response to an external force, the rotation being about an axis running through the fulcrum site and approximately orthogonal to the rod body, and the external force including a force effectuated by the presence of the target substance.

12. The detector device of claim 11, wherein the fulcrum site is approximately at a longitudinal center of the rod body.

13. The detector device of claim 11, further comprising:
at least one detection mass coupled to the rod body on a detection side of the rod body, the detection side being a section of the rod body between the fulcrum site and detection end; and
at least one counterbalance mass coupled to the rod body on a counterbalance side of the rod body, the counterbalance side being a section of the rod body between the fulcrum site and the counterbalance end.

14. The detector device of claim 13, wherein a mass value of the at least one detection mass is approximately equal to a mass value of the at least one counterbalance mass.

15. The detector device of claim 13, wherein the at least one detection mass and the at least one counterbalance mass, are composed of the same material, which is a conductive, non-magnetic material.

16. The detector device of claim 13, wherein the fulcrum site is at approximately a center of mass of the rod body, and a center of mass of the at least one detection mass is slightly further from the fulcrum site than the center of mass of the at least one counterbalance mass.

17. The detector device of claim 13, wherein a position of the at least one detection mass, a position of the at least one counterbalance mass, or both, is adjustable with respect to the rod body.

18. The detector device of claim 13, wherein the at least one detection mass includes at least two distinct mass bodies.

19. The detector device of claim 18, wherein the at least two distinct mass bodies comprise a primary mass body and a secondary mass body, wherein the mass value of the primary mass body is greater than the mass value of the secondary mass body, and wherein the secondary mass body is distanced further from the support shaft than the primary mass body.

20. The detector device of claim 19, wherein a position of the secondary mass body is adjustable with respect to the rod body.
